(19) United States
(12) Patent Application Publication
(10) Pub. No.: US 2007/0159764 A1
(43) Pub. Date: Jul. 12, 2007

(54) Remote sensor for controlling ionization systems

(75) Inventors: Brian Warren, Reno, CA (US); Edward Oldynski, Martinez, CA (US)

Correspondence Address: MKS Instruments Inc., 1750 North Loop Road, Alameda, CA, 94502, US

(73) Assignee: MKS Instruments Inc.

(21) Appl. No.: 11/648,275

(22) Filed: Dec. 29, 2006

Related U.S. Application Data
(60) Provisional application No. 60/758,435, filed on Jan. 11, 2006.

(51) Int. Cl. H02H 1/00

(52) U.S. Cl. 361/212

(57) ABSTRACT

Ionizers are monitored and controlled by a small remote sensor that can read the same as a charge plate monitor located at a different location. Balance amplification to compensate for the remote sensor's small size maintains accuracy. Balance and swing are measured directly. Balance pre-amplification, smoothing, and remote offset correlation is accomplished with signal-processing modules based on historical data. The signal-processing modules are embedded into a microprocessor.

### CROSS-REFERENCE TO RELATED APPLICATIONS

This application claims priority to U.S. Provisional Application 60/758,435 entitled “Remote Sensor for Controlling Ionization Systems” filed Jan. 11, 2006.

### STATEMENT REGARDING FEDERALLY SPONSORED RESEARCH

Not Applicable

### REFERENCE TO A MICROFICHE APPENDIX

Not Applicable

### BACKGROUND OF THE INVENTION

1. Field of the Invention

This invention relates to ionizers, which are designed to remove or minimize static charge accumulation. Ionizers remove static charge by generating air ions and delivering those air ions to a charged target.

One type of ionizer uses corona electrodes to produce air ions. During operation, debris can build up on the corona electrodes and change the ionizer performance. Performance parameters include balance, swing, and discharge time.

Sensor feedback to the ionizer is desirable for two reasons. The first reason is maintaining the ionizer's balance and discharge time within predetermined limits. The second reason is notifying the user when balance, swing, and discharge time breach the predetermined limits.

The current invention uses a novel remote sensor to generate a feedback signal. That remote sensor is used to monitor the ionizer. The feedback signal is used to adjust the ionizer and to initiate alarms.

2. Description of Related Art

Ionizers remove static charge by ionizing air molecules, and delivering those generated air ions to a charged target. The air ions are most commonly created by high voltage applied to corona electrodes. Positive air ions neutralize negative static charges, and negative air ions neutralize positive static charges.

From a performance view, ionizers are defined by balance, discharge time, and swing.

Balance is a measure of closeness to zero volts. After the initial charge is removed from a target, that target would ideally equilibrate at zero volts from ground. In practice, the target equilibrates near zero volts from ground, but seldom exactly at zero volts.

Balance is normally specified as a range around zero. For example, ionizer balance may be specified as −5 volts to +5 volts. If voltages between −5 and +5 volts do not affect products handled within the workstation, the products can be handled safely. But if voltages between −2 and +2 volts affect products handled within the workstation, an ionizer with a tighter balance specification is appropriate.

Discharge time is a measure of how fast a given level of charge can be removed from a charged target. Low discharge times are better than high discharge times. For example, an ionizer with a discharge time of 3 seconds could be used for a moving charged target that only remains under the ionizer for 3 seconds.

Swing is the peak-to-peak voltage that an AC or pulsed DC ionizer produces at the target. Static sensitive products can be damaged by high swing, even though the average balance is near zero.

Historically, charge plate monitors have been used to measure the balance and discharge time of an ionizer during setup. But, due to size and expense, charge plate monitors are impractical for generating continuous on-line balance and discharge time measurements.

Charge plate monitors are not optimally designed for measuring swing. The reason is that charge plate monitors have high input capacitance, producing a low-pass filter cutoff that attenuates the desired AC signal that produces the swing. This will decrease the signal-to-noise ratio to uncorrelated noise.

Due to increased noise in the swing measurement, charge plate monitor swing values can have a large variance, which increases as the distance between the ionizer and charge plate monitor increases.

Static sensitive product lines require tight control of balance, discharge time, and swing. Unfortunately, debris buildup on corona electrodes affects ionizer performance. Other mechanisms also cause the ionizer to drift.

Sensor feedback to continuously adjust the ionizer is required to meet existing requirements. Prior art ionizers utilize sensor measurement and feedback, and some have been miniaturized to allow placement in the work zone. But these prior art sensors only approximate ionizer performance at the target. That is, the prior art sensors do not produce the same measurements that a charged plate monitor would measure at the critical workstation location.

In addition, sensor miniaturization leads to insensitive balance measurements. The reason is that as the sensor gets smaller, the collection plate also gets smaller. For example, the collection plate may be reduced twenty-fold. Since balance is presumably a value close to zero, resolving small balance differences becomes problematic.

A need exists for an ionization feedback sensor that measures two of the three fundamental performance parameters: balance and swing. With control of balance and swing, constancy of discharge time can be presumed with a high level of confidence. The sensor data should continuously indicate parameter performance at the workstation, rather than near the ionizer. A small sensor size is needed because the sensor has to occupy valuable workstation space and fit within the existing geometry of the test environment.

The needed sensor also requires a way to magnify the balance reading without degrading the quality of the swing measurement.

Furthermore, the user does not always have the option of placing the sensor at the most critical position within the workstation. So, a need exists to match the remote sensor's response at one location to a known (typically, a charged plate monitor) response at another location.

### BRIEF SUMMARY OF THE INVENTION

The present invention utilizes a low input impedance ionization sensor, which measures balance and swing. Roughly speaking, discharge time is presumed stable when the swing and balance remain stable.

The remote sensor has a small size, which allows full time positioning within the workstation. Hence, the measurement directly reflects the conditions where work takes place. However, the remote sensor does not have to be placed at the critical location. Sensor readings mimic what a charge plate monitor at the critical location would report.

The remote sensor's hardware is similar to a charge plate monitor. But the size, input impedance, and capacitance differ. Due to low input capacitance, the sensor can more accurately measure voltage swings. In addition, the low input impedance is less sensitive to noise than a charge plate monitor.

A microprocessor is integrated into the invented remote sensor. In a preferred embodiment, the microprocessor is contained within the sensor chassis. The microprocessor contains three signal-processing modules. The first signal-processing module performs the accumulation function. The accumulation function compensates for the balance insensitivity that arises from small sensor plate size. In one preferred embodiment, the gain of the accumulation function provides a 40 dB improvement in the balance measurement.

The second signal-processing module is the balance matching function. The balance matching function allows the invented sensor in one location to match the readings of a charge plate monitor in another location. During setup, a charge plate monitor (or equivalent instrumentation) is placed at the target location, and the ionizer is adjusted to generate a zero balance at the charge plate monitor. This maintains a short-term charge plate monitor balance (short-term meaning the duration of the setup time). The invented remote sensor is placed at another location suited to the logistics of the environment, and sensor pre-offset is adjusted via the microprocessor to produce a zero output balance. From this time onward, the zero balance of the invented sensor will match the set balance of the charge plate monitor.

Additionally, the swing voltage at the remote sensor location will be proportional to the swing voltage at the charge plate monitor location. Hence, a single calibration factor in addition to the pre-offset allows swing matching as well.

The third signal-processing module is the smoothing function. The smoothing function makes the balance and swing outputs materially insensitive to environmental changes. Examples of environmental changes include electrostatic discharges due to moving tool components and robot arms that move between the ionizer and sensor.

Sensor information is fed back to the high voltage power supply(s) of the ionizer. In turn, the high voltage power supply(s) is adjusted to maintain tight control of two of the three fundamental parameters: balance and swing. The feedback path may include an intermediate module placed between the ionizer and the remote sensor.

Objects of the invention include (1) providing an ionization sensor that is small enough to fit inside the work station, (2) providing an ionization sensor with sufficiently low capacitance and input impedance to most effectively measure swing, (3) amplifying the balance signal generated by the small charge plate without degrading the swing signal, (4) matching the sensor outputs (balance and swing) to the outputs of a charge plate monitor, even though the sensor and charge plate monitor are at different locations, (5) feeding the sensor output back to the ionizer to maintain stable ionizer performance.

### BRIEF DESCRIPTION OF THE SEVERAL VIEWS OF THE DRAWINGS

FIG. 1 is a schematic that shows the invented remote sensor receiving air ions from one or more ionizers. Information on balance and swing and are fed back to the ionizer power supply(s) through an intermediate controller module.

FIG. 2 is a schematic that shows the front end of the signal processing flow.

FIG. 3 diagrams the three signal-processing modules, which are executed by the microprocessor.

FIG. 4 shows correlation of the raw output data signal for a charge plate monitor and the invented sensor. The values for swing and balance correlate accordingly.

### DETAILED DESCRIPTION OF THE INVENTION

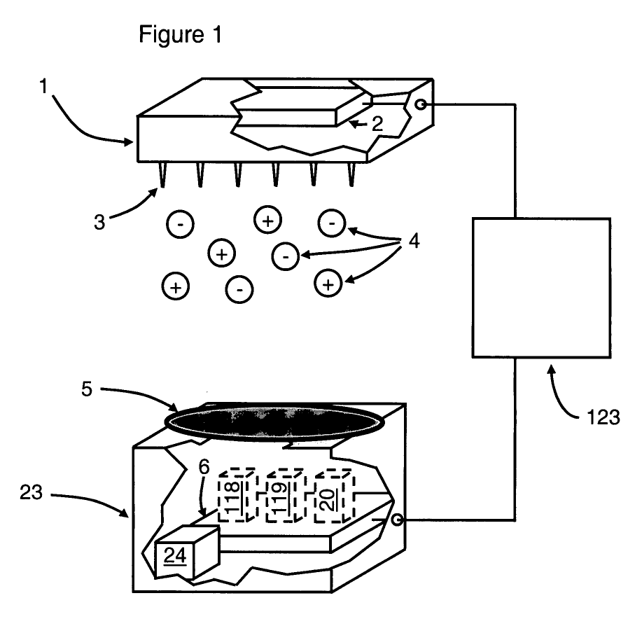

FIG. 1 shows one or more ionizers 1 and a remote sensor 23 operating in a feedback loop through an intermediate controller module 123. One or more high voltage power supplies 2 places a high voltage on the corona electrodes 3 to produce air ions 4.

The invented remote sensor 23 receives the air ions 4 which reach the remote sensor plate 5. These air ions 4 embody the information on both balance and swing, but the remote sensor plate 5 itself does not separate the swing signal from the balance signal.

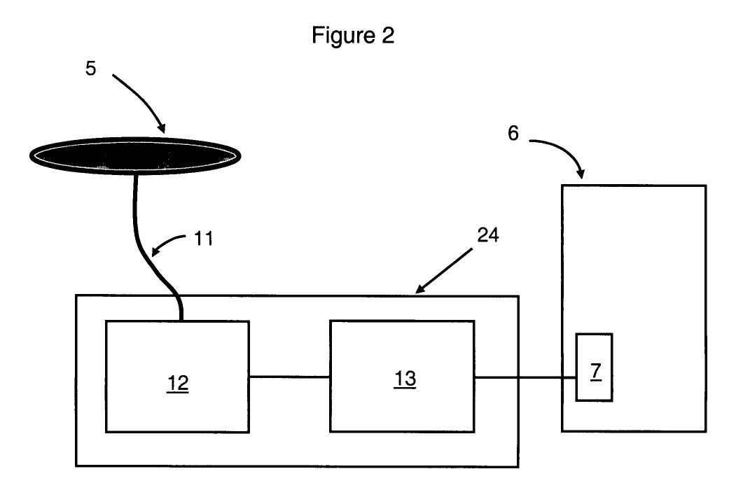

As shown in FIG. 2, a pre-amplifier 24 receives the total signal from the remote sensor plate 5 through the antenna 11. The pre-amplifier 24 contains a low impedance transconductance amplifier 12 and an adjustable gain controller 13. Both the low impedance transconductance amplifier 12 and the adjustable gain controller 13 are built from commercially available components and based on low-drift op amps. Functionally, the pre-amplifier 24 amplifies the balance portion of the total signal (the balance signal) without modifying the swing portion of the total signal (the swing signal). This is accomplished by setting the cutoff frequency of the amplifier above the highest ionizer frequency, but below 60 Hz to in order to avoid 60 Hz hum. In the preferred embodiment, the transconductance amplifier 12 has a nominal transconductance of 50 dB. The adjustable gain controller 13 allows the pre-amplifier 24 an increased dynamic range and, in turn, an increased operating distance from ionizer 1 to target. In the preferred embodiment, the adjustable gain controller 13 has an adjustment range of 40 dB. The output of the pre-amplifier 24 is connected to the analog-to-digital converter 7 input of the microprocessor 6. Additionally, it is connected in such a way as to take advantage of the microprocessor 6 internal pre-amplifier, which affords another 24 dB adjustment gain.

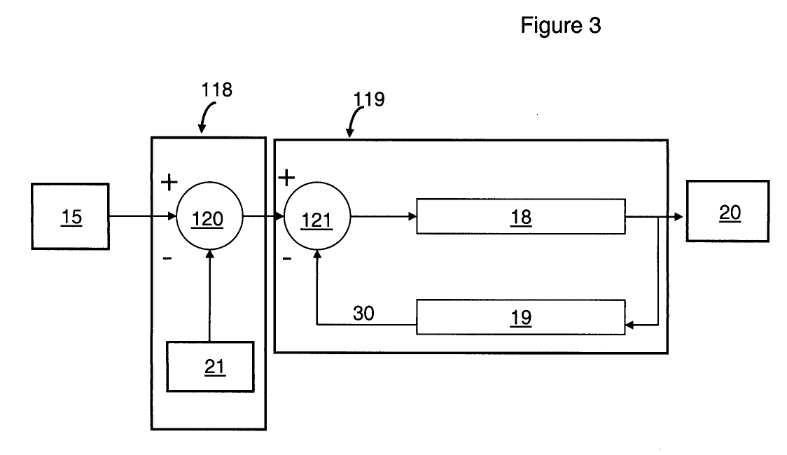

The microprocessor 6 is programmed with three signal-processing modules, diagrammed in FIG. 3. The three signal-processing modules are:

(a) the accumulator function 119,

(b) the balance matching function 118, and

(c) the smoothing function 20.

Of the three signal-processing modules, the accumulator function 119 and the balance matching function 118 are necessary. The smoothing function 20 is not essential for the remote sensor's operation, but it reduces noise and decreases sensitivity to undesired effects (robot arm, ESD, etc).

The preferred embodiment utilizes the accumulator function 119 diagrammed in FIG. 3. At this point, the swing has already been measured and the peak measurements have been stored in the swing memory 15. The signal has also passed through the balance matching function 118 (not a prerequisite for operation of the accumulator function 119). The accumulator 18 sums the input from the swing memory 15. This effectively removes the time-varying AC component (swing signal) and accumulates the non-time-varying DC component (balance signal).

If there were no feedback, the DC component (balance) would eventually drive the accumulator 18 output to infinity (or to the limits of the register). So, negative feedback is introduced. The accumulator summing block 121 sums (a) the most recent digital sample, and (b) the negative feedback 30 from the accumulator 18. The amount of the negative feedback 30 is determined by the gain block 19, which is set in the preferred embodiment to 0.01. A gain block 19 setting of 0.01 gives a balance gain of roughly 40 dB.

In summary, the accumulator function 119 performs as (a) a low-pass filter with cutoff frequency below the emitter frequency and (b) a DC gain to enhance the balance. It matches the performance of the front-end of a charge plate monitor. But because the accumulator function 119 is performed after the swing is measured and stored in the swing memory 15, the swing information is not degraded (i.e. filtered). This gives the invented remote sensor 23 a significant advantage over a charge plate monitor.

The balance matching function 118 matches invented remote sensor 23 readings at one location to charge plate monitor readings at a second location. Referring to FIG. 3, the matching function algorithm 118 operates as described below.

After the invented remote sensor 23 is placed in the desired location, and the ionizer is set to the desired configuration, the remote sensor 23 will read a particular balance at the output of the accumulator 18, which corresponds to this ionizer setup. To correlate with the charge plate monitor, the remote sensor's balance output must initially be driven to zero. Adding a fixed balancing number 21 to the balance summing block 120 does this. Initially, the fixed balancing number 21 has a value of zero, and when added to the input of the accumulator function 119 by the balance summing block 120, has no effect. At this point, the output of the accumulator 18 determines the appropriate value for the fixed balancing number 21. The fixed balancing number 21 depends on the gain block 19. In the preferred embodiment, where the gain block is set at 0.01, the fixed balancing number 21 is calculated as the initial accumulator 18 output divided by 100. Thus, if the initial accumulator output for a particular environment is −1200, then the fixed balancing number 21 is set to −12. This will drive the nominal value of the accumulator 18 to zero.

At this point, a CPM at the target location will read zero, and the remote sensor 23 at a different location will also read zero. Note that an outcome of this embodiment is that swing measured at the CPM and the output of the accumulator becomes a fixed proportion. This is not true if the fixed balancing number 21 has not been set.

In an example, if (a) the swing at the charge plate monitor location were ±100V and (b) the measured swing of the accumulator were ±2400, a calibration factor could be calculated as 2400/100=24 units per volt. This calibration holds for changes in the environment. If the swing were to change from 100 to 101 volts at the CPM, the remote sensor would change from 2400 to 2424 units. Similarly, if the balance at the CPM changes −10 volts, the remote sensor changes −240 units.

The smoothing function 20 allows the invented remote sensor 23 to have reduced sensitivity to undesired signals, such as random ESD discharges or movement of robot arms. A charge plate monitor reacts to these undesired signals. The invented remote sensor 23 ignores or minimizes the undesired factors.

The smoothing function 20 comprises a low-pass filter applied to the peak and balance outputs determined from the previous signal-processing modules 118, 119. In a preferred embodiment, the low-pass filter is a single-tap IIR filter with feedback 0.20.

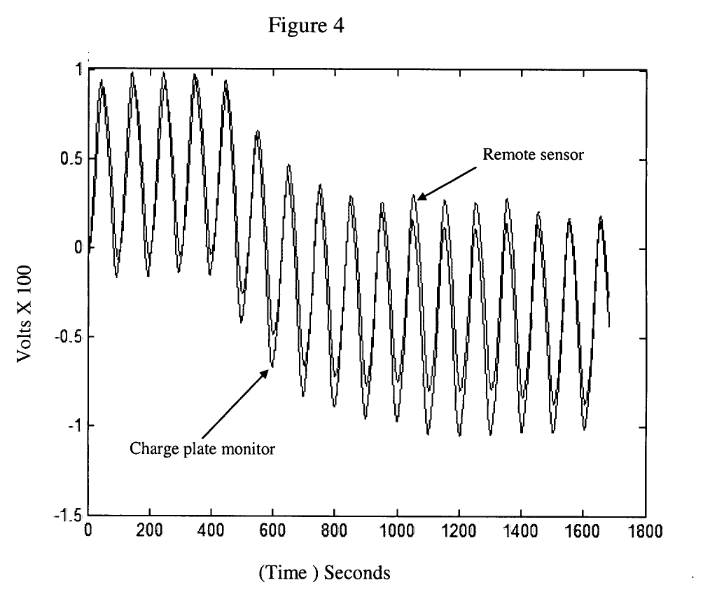

Prototype data demonstrates an excellent agreement between the invented remote sensor and a charge plate monitor. This is seen in FIG. 4, which shows the tracking of a charge plate monitor to the invented remote sensor for an extreme change in ionization environment. In this very conservative situation, the outputs match not only in amplitude, but also in time response to the change.

Operation of this remote sensor 23 may incorporate an a priori knowledge of ionizer 1 frequency. This allows the remote sensor to make frequency-aware calculations, maintain the same number of sample points regardless of ionizer 1 period. This will maintain accuracy over the operating ionizer 1 frequency range. It maintains the same microprocessor memory usage over the operating emitter frequency range. It will also produce comparable performance to the 60 Hz digital low-pass filter, regardless of ionizer 1 frequency.

The invention claimed is:

1. A method of using a remote sensor to monitor and adjust ionizers comprising:
(a) receiving air ions from an ionizer to generate a combined analog balance and swing signal;
(b) passing said combined analog balance and swing signal through an analog pre-amplifier to produce an amplified balance signal and a non-amplified swing signal;
(c) digitizing said amplified balance signal and said non-amplified swing signal;
(d) separating said amplified balance signal from said non-amplified swing signal with an accumulator function;
(e) matching said remote sensor readings to known readings at a different location from said remote sensor.

2. Claim 1 where said receiving step (a) is performed with a remote sensor plate.

3. Claim 2 where said remote sensor plate is connected to a low-impedance, low capacitance pre-amplifier.

4. Claim 1 where said passing step (b) uses an analog pre-amplifier with an adjustable gain.

5. Claim 1 where said digitizing step (c) uses an analog-to-digital converter contained within a microprocessor.

6. Claim 1 where said separating step (d) further digitally amplifies said amplified balance signal.

7. Claim 1 where said accumulator function in separating step (d) comprises an accumulator and a gain block.

8. Claim 1 where said accumulator function in separating step (d) comprises a feedback to an accumulator summing block.

9. Claim 1 where said matching step (e) utilizes a balance matching function.

10. Claim 9 where said matching step (e) further utilizes said accumulator function.

11. Claim 1 which further comprises a smoothing function.

12. Claim 11 where said smoothing function utilizes a low pass filter.

13. Claim 12 where said low pass filter comprises a single tap IIR filter.

14. Claim 1 where said accumulator function is executed by a microprocessor.

15. Claim 9 where said balance matching function is executed by a microprocessor.

16. Claim 1 where said known readings in matching step (e) are measured with a charge plate monitor.

17. A remote sensor for monitoring and adjusting ionizers comprising:
(a) a remote sensor plate;
(b) an analog pre-amplifier; and
(c) a microprocessor

18. Claim 17 where said remote sensor plate is connected to said pre-amplifier with a wire or antenna.

19. Claim 17 where said analog pre-amplifier comprises a low impedance transductance amplifier and an adjustable gain controller.

20. Claim 17 where said microprocessor is programmed with a balance matching function.

21. Claim 17 where said microprocessor is programmed with an accumulator function.

22. Claim 17 where said microprocessor is programmed with both an accumulator function and a balance matching function.

23. Claim 17 where said microprocessor is programmed with a smoothing function.

24. Claim 17 where said microprocessor contains an analog-to-digital converter.

25. Claim 24 where said analog-to-digital converter is connected to the output of said analog pre-amplifier.

26. Claim 17 which further includes a 60 Hz digital filter

27. Claim 26 where said 60 Hz digital filter is specified for 30 to 70 db of immunity to 60 Hz hum.

28. Claim 17 where balance and swing measurements are deliverable in digital format.
